(19) United States
(12) Patent Application Publication
(10) Pub. No.: US 2025/0063486 A1
(43) Pub. Date: Feb. 20, 2025

(54) METHOD AND APPARATUS FOR NETWORK SELECTION FOR MULTIPLE ACCESS IN WIRELESS COMMUNICATION SYSTEM

(71) Applicant: SAMSUNG ELECTRONICS CO., LTD., Suwon-si (KR)

(72) Inventor: Sangjun MOON, Suwon-si (KR)

(21) Appl. No.: 18/809,102

(22) Filed: Aug. 19, 2024

(30) Foreign Application Priority Data
Aug. 17, 2023 (KR) 10-2023-0107351

(51) Int. Cl. H04W 48/18; H04W 48/08

(52) U.S. Cl. CPC H04W 48/18; H04W 48/08

(57) ABSTRACT

The disclosure relates to a 5G or 6G communication system for supporting a higher data transmission rate. According to the disclosure, a 3GPP 5GS (5G System) may provide a multiple-access-based network selection function for selecting a network for multiple 3GPP accesses in order to provide multiple 3GPP accesses to a wireless terminal.

### CROSS REFERENCE TO RELATED APPLICATION

The present application claims priority to Korean Patent Application No. 10-2023-0107351, filed on Aug. 17, 2023, the entire contents of which is incorporated herein for all purposes by this reference.

### BACKGROUND

### 1. Field

The disclosure relates to a method for providing multiple-access to a wireless terminal in a wireless communication network, for example, in a third generation partnership project 5th generation system (3GPP 5GS). Specifically, the present disclosure relates to a method for providing multiple 3GPP accesses to a wireless terminal.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Meanwhile, with the development of the above mobile communication system, a need for a method for performing multiple-access-based network selection has arisen.

### SUMMARY

The present disclosure provides a multiple-access-based network selection method for selecting a network for multiple 3GPP accesses in order for a 5G system to provide multiple 3GPP accesses to a wireless terminal.

According to one embodiment of the disclosure, a multiple-access-based network selection function for selecting a network for multiple 3GPP accesses can be provided in order for a 3GPP 5GS (5G System) to provide multiple 3GPP accesses to a wireless terminal.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates 3GPP and non-3GPP access traffic steering/switching/splitting according to an embodiment of the present disclosure;

FIG. 2 illustrates 3GPP and 3GPP access traffic steering/switching/splitting according to an embodiment of the present disclosure;

FIG. 3 illustrates a network selection list update operation for 3GPP and 3GPP access traffic steering/switching/splitting of a single CN according to an embodiment of the present disclosure;

FIG. 4 illustrates a network selection list update operation for 3GPP and 3GPP access traffic steering/switching/splitting of multiple CNs according to an embodiment of the present disclosure;

FIG. 5A illustrates a signal flow of a network selection list update operation for 3GPP and 3GPP access traffic steering/switching/splitting of a single CN according to an embodiment of the present disclosure;

FIG. 5B illustrates a signal flow of a network selection list update operation for 3GPP and 3GPP access traffic steering/switching/splitting of a single CN according to an embodiment of the present disclosure;

FIG. 5C illustrates a signal flow of a network selection list update operation for 3GPP and 3GPP access traffic steering/switching/splitting of a single CN according to an embodiment of the present disclosure;

FIG. 6A illustrates a signal flow of a network selection list update operation for 3GPP and 3GPP access traffic steering/switching/splitting of multiple CNs according to an embodiment of the present disclosure;

FIG. 6B illustrates a signal flow of a network selection list update operation for 3GPP and 3GPP access traffic steering/switching/splitting of multiple CNs according to an embodiment of the present disclosure;

FIG. 6C illustrates a signal flow of a network selection list update operation for 3GPP and 3GPP access traffic steering/switching/splitting of multiple CNs according to an embodiment of the present disclosure;

FIG. 7 illustrates a structure of a terminal according to an embodiment of the present disclosure; and

FIG. 8 illustrates a structure of a network entity according to an embodiment of the present disclosure.

### DETAILED DESCRIPTION

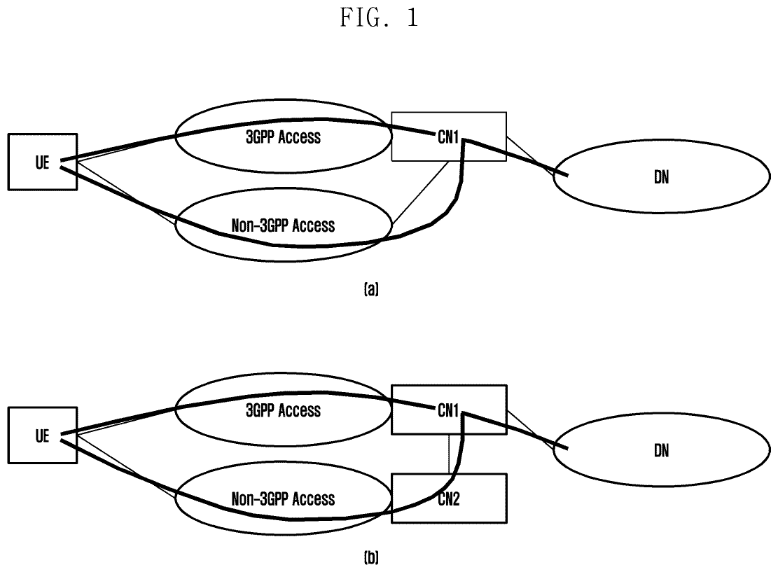

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, preferred embodiments of the disclosure will be described in detail with reference to the accompanying drawings. In this case, it should be noted that in the accompanying drawings, the same components are denoted by the same reference numerals as much as possible. In addition, detailed descriptions of well-known functions and constitutions that may obscure the gist of the disclosure will be omitted.

In describing the embodiments of the disclosure, descriptions of technical contents that are well known in the technical field to which the disclosure belongs and are not directly related to the disclosure will be omitted. This is to more clearly convey the gist of the disclosure by omitting unnecessary description.

For the same reason, some components are exaggerated, omitted, or schematically illustrated in the accompanying drawings. In addition, the size of each component does not fully reflect the actual size. In each figure, the same or corresponding elements are assigned the same reference numerals.

Advantages and features of one or more embodiments of the disclosure and methods of accomplishing the same may be understood more readily by referring to the following detailed description of the embodiments of the disclosure and the accompanying drawings. The disclosure may, however, be embodied in many different forms and should not be construed as limited to embodiments set forth herein; rather these embodiments are provided so that this disclosure will be thorough and complete, and will fully convey the scope of the disclosure only defined by the claims to one of ordinary skill in the art. The same reference numerals refer to the same elements throughout the disclosure.

In this case, it will be understood that each block of process flowcharts and combinations of the flowcharts may be performed by computer program instructions. Because these computer program instructions may be embedded in a processor of a general-purpose computer, a special-purpose computer, or other programmable data processing apparatuses, the instructions executed through the processor of the computer or other programmable data processing apparatus generates modules for performing the functions described in the flowchart block(s). Because these computer program instructions may also be stored in a computer-executable or computer-readable memory that may direct the computer or other programmable data processing apparatus so as to implement functions in a particular manner, the instructions stored in the computer-executable or computer-readable memory are also capable of producing an article of manufacture containing instruction modules for performing the functions described in the flowchart block(s). Because the computer program instructions may also be embedded into the computer or other programmable data processing apparatus, the instructions for executing the computer or other programmable data processing apparatuses by generating a computer-implemented process by performing a series of operations on the computer or other programmable data processing apparatuses may provide operations for executing the functions described in the flowchart block(s).

Also, each block may represent part of a module, segment, or code that includes one or more executable instructions for executing a specified logical function(s). It should also be noted that, in some alternative implementations, the functions described in the blocks may occur out of the order noted in the drawings. For example, two blocks illustrated in succession may in fact be executed substantially concurrently, or the blocks may sometimes be executed in a reverse order, depending on the functions involved therein.

The term “-unit,” as used in the present embodiment of the disclosure refers to a software or hardware component, such as field-programmable gate array (FPGA) or application-specific integrated circuit (ASIC), which performs certain tasks. However, the term “-unit” is not limited to software or hardware. The term “-unit” may be configured in an addressable storage medium or may be configured to reproduce one or more processors. Therefore, for example, the term “-unit” includes elements, such as software elements, object-oriented software elements, class elements, and task elements, processes, functions, attributes, procedures, subroutines, segments of program code, drivers, firmware, microcodes, circuits, data, databases, data structures, tables, arrays, and variables. Functions provided in the elements and the “-units” may be combined with fewer elements and “-units,” or may be separated from additional elements and “-units” Furthermore, the elements and the “-units” may be implemented to reproduce one or more central processing units (CPUs) in the device or secure multimedia card.

Hereinafter, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a 5G UE, a cellular phone, a smartphone, computer, or multimedia systems capable of performing communication functions. Also, embodiments of the disclosure may be applied to other communication systems having a similar technical background or channel type to that of the embodiments of the disclosure. Also, it will be understood by one of ordinary skill in the art that embodiments of the disclosure may be applied to other communication systems through some modifications without departing from the scope of the disclosure. Examples of such communication systems may include 5th generation mobile communication technologies (5G, new radio, and NR) developed beyond LTE-A, and in the following description, the 5G may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Hereinafter, an operation principle of the disclosure is described in detail with reference to the accompanying drawings. In describing the disclosure, a detailed description of a related known function or constitution will be omitted if it is deemed to make the gist of the disclosure unnecessarily vague. Furthermore, terms to be described hereunder have been defined by taking into consideration functions in the disclosure, and may be different depending on a user, an operator's intention or practice. Accordingly, each term should be defined based on contents over the entire specification.

Herein, terms to identify access nodes, terms to refer to network entities, terms to refer to messages, terms to refer to interfaces between network entities, terms to refer to various types of identification information, etc., are examples for convenience of explanation. Therefore, the disclosure is not limited to the terms to be described later, and other terms referring to entities having an equivalent technical meaning may be used.

For convenience of description, the disclosure uses terms and names defined in 5GP and NR standards, which are the latest standards among existing communication standards defined by the 3GPP group. However, the disclosure is not limited by the terms and names, and may be equally applied to a wireless communication network following another standard. Particularly, the disclosure may be applied to 3GPP 5GS/NR (e.g., 5th generation mobile communication standard).

In order to increase transfer rate, increase transfer stability, and reduce transfer latency, a wireless communication network, more specifically, 5G system, may provide multiple-access. Conventionally, there was a scheme of using only one 3GPP access and additionally using a non-3GPP access to provide multiple-access to a terminal. However, the coverage of the non-3GPP access may be relatively more restricted than that of the 3GPP access. In addition, there are various types of 3GPP accesses. For example, a 3GPP access may be classified into a public land mobile network (PLMN) and a non-public network (NPN), and can be classified into a sub-6 GHZ band and a higher mmWave band depending on the supported frequency, and may be classified into a terrestrial network (TN) and a non-terrestrial network (NTN). TN and NTN may also be further classified into evolved UMTS terrestrial radio access network (EUTRA), new radio (NR), low Earth orbit (LEO), geostationary orbit (GEO), etc., depending on a radio access technology (RAT). Therefore, a single wireless terminal may use multiple different types of 3GPP accesses simultaneously. For example, 5G system may provide multiple 3GPP accesses to wireless terminals. To support this, a method for selecting a network for multiple 3GPP accesses is required.

In other words, in order for a wireless communication network, more specifically, 5G system to provide multiple 3GPP accesses to wireless terminals, a method for selecting a network for multiple 3GPP accesses is required. Conventionally, only one 3GPP access was used, so network selection was performed for only one 3GPP access. After selecting one network, other networks may be searched, but the searched other networks were not selected, which was a single-access operation.

FIG. 1 illustrates 3GPP and non-3GPP access traffic steering/switching/splitting according to an embodiment of the present disclosure.

In this case, in order to increase transfer rate, increase transfer stability, and reduce transfer latency, the wireless communication network, more specifically, 5G system may use only one 3GPP access and additionally use non-3GPP access to provide multiple accesses to the terminal. In this case, as illustrated in (a) of FIG. 1, 3GPP access and non-3GPP access may be provided to one terminal through a single CN, and data services may be provided to the terminal. Alternatively, as illustrated in (b) of FIG. 1, 3GPP access and non-3GPP access may be provided to one terminal using multiple CNs (e.g., CN1 and CN2), and data services may be provided to the terminal.

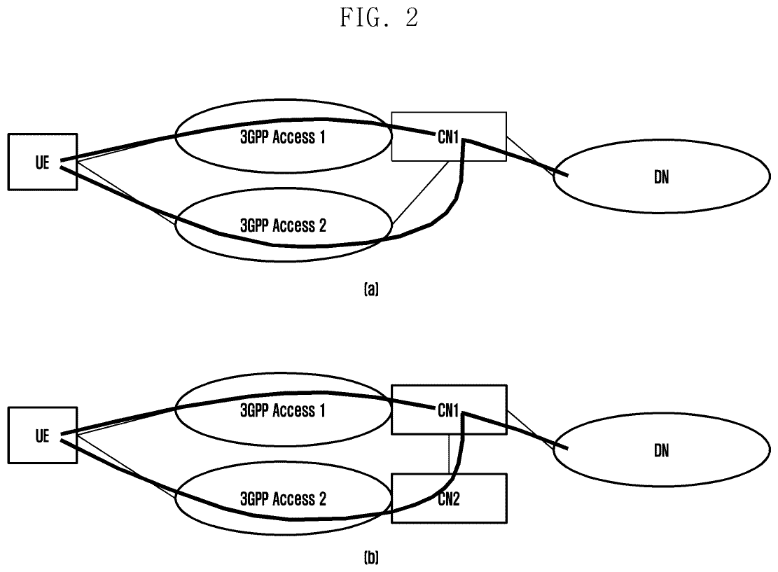

Meanwhile, FIG. 2 illustrates 3GPP and 3GPP access traffic steering/switching/splitting according to an embodiment of the present disclosure.

In this case, in order to increase the transfer rate, increase the transfer stability, and reduce the transfer latency, the wireless communication network, more specifically, 3GPP 5GS (5G System), may use one 3GPP access and additionally use another 3GPP access to provide multiple-access to the terminal. In this case, multiple 3GPP accesses may be provided to one terminal through a single CN as illustrated in (a) of FIG. 2, and data services may be provided to the terminal. Alternatively, multiple 3GPP accesses may be provided to one terminal using multiple CNs (e.g., CN1 and CN2) as illustrated in (b) of FIG. 2, and data services may be provided to the terminal.

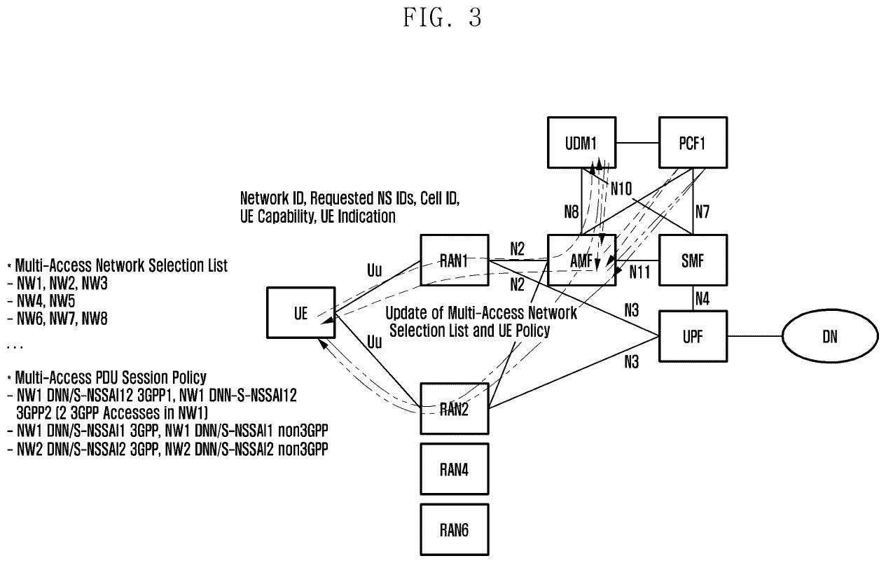

Meanwhile, FIG. 3 illustrates a network selection list update operation for 3GPP and 3GPP access traffic steering/switching/splitting of a single CN according to an embodiment of the present disclosure.

The terminal (e.g., UE) may search and select another network after selecting one network (multi-access). In one embodiment, a single CN is used, and the second network may be a network provided by the same CN as the first network.

In this case, the following operations may be performed by considering UE capability, a UE indication, a network indication, UDM subscription, policy, etc.:
NSSF/NSACF, etc. may select AMF in consideration of a network ID, requested NS IDs, an access type, a cell ID, UE capability, a UE indication;
Multi-access network selection list may be updated and UE policy may be updated (stand-alone non-public network (SNPN) and/or PLMN list prepared according to a cell ID) as a steering of roaming (SoR) process in response to registration, by selecting UDM subscriber information, PCF policy information, MA access policy;
When creating an MA PDU session with two simultaneously selected networks, supported simultaneously SMF/UPF may be selected; and/or
When creating a MA PDU session with one selected network, simultaneously supported SMF/UPF may be selected, and the same SMF/UPF may be selected when creating a PDU session with the second network later.

According to one embodiment, in a case where the UE selects a network, depending on whether to select SNPN or PLMN, whether only the PLMN ID is identified or the network ID is identified in addition may vary. Accordingly, the UE may determine whether to preferentially select SNPN or PLMN from the network access selection list according to the intent of the Application.

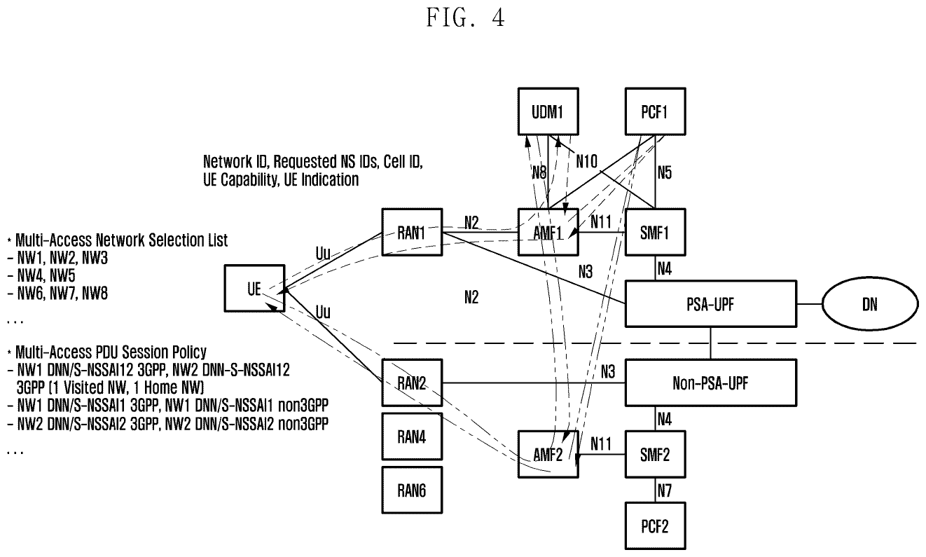

Meanwhile, FIG. 4 illustrates a network selection list update operation for 3GPP and 3GPP access traffic steering/switching/splitting of multiple CNs according to an embodiment of the present disclosure.

The terminal (e.g., UE) may search and select another network after selecting one network (multi-access). In one embodiment, multiple CNs are used, and the second network may be a network provided by another CN that has a service contract with the first network, such as roaming.

In this case, the following operations may be performed by considering UE capability, a UE indication, a network indication, UDM subscription, policy, etc.:
NSSF/NSACF, etc. may select AMF in consideration of a network ID, requested NS IDs, an access type, a cell ID, UE capability, a UE indication;
Multi-access network selection list may be updated and UE policy may be updated (SNPN and/or PLMN list prepared according to a cell ID) as a SoR process in response to registration, by selecting UDM subscriber information, PCF policy information, MA access policy;
When creating an MA PDU session with two simultaneously selected networks, supported simultaneously SMF/UPF may be selected; and/or
When creating a MA PDU session with one selected network, simultaneously supported SMF/UPF may be selected, and the same SMF/UPF may be selected when creating a PDU Session with the second network later.

According to one embodiment, in a case where the UE selects a network, depending on whether to select SNPN or PLMN, whether only the PLMN ID is identified or the network ID is identified in addition may vary. Accordingly, the UE may determine whether to preferentially select SNPN or PLMN from the network access selection list according to the intent of the Application.

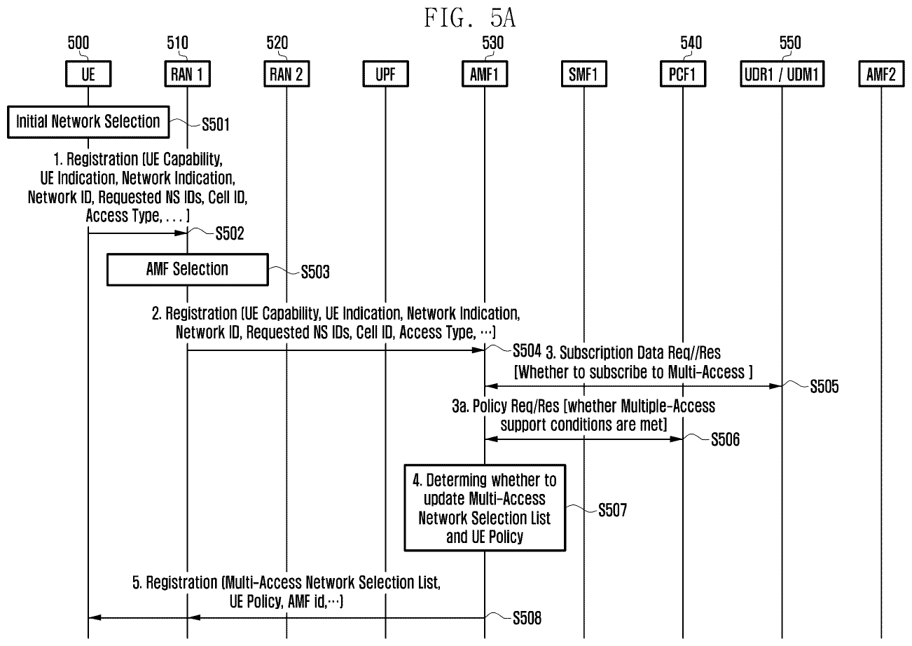

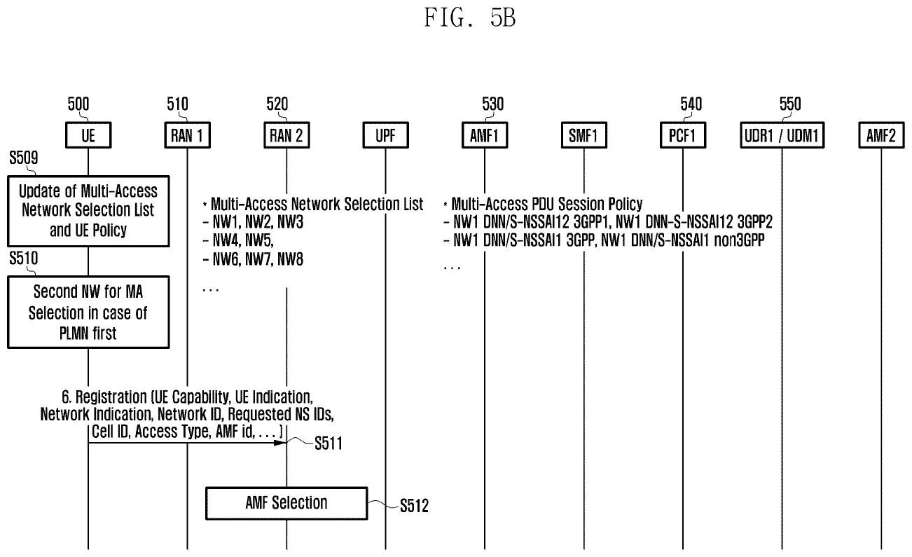

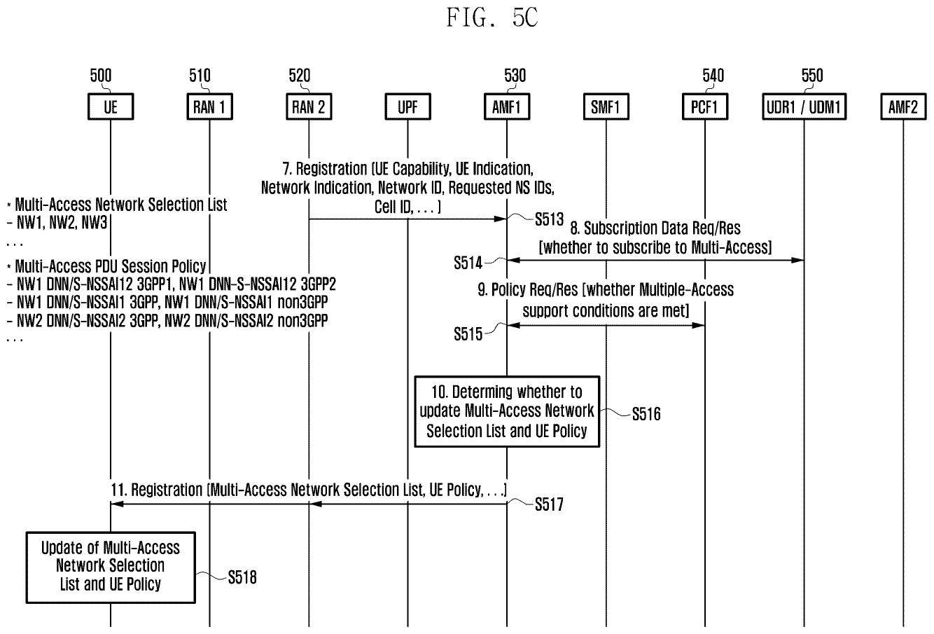

Meanwhile, FIGS. 5A to 5C illustrate signal flows of a network selection list update operation for 3GPP and 3GPP access traffic steering/switching/splitting of a single CN according to an embodiment of the present disclosure.

In S501, a terminal (e.g., UE) 500 that has selected a first network may transmit a registration request to an RAN1 510, which is the base station of a corresponding network, in the network selected in operation 1 of S502. The registration request may include UE capability indicating whether multiple-access may be used, a UE indication indicating whether multiple-access is to be used, a network indication indicating whether multiple-access is supported, a network ID to be accessed, requested network slice (NS) IDs to be accessed, a cell ID to which the UE has accessed, an access type to which the UE is accessed, etc.

In S503, the RAN1 510 may select an AMF based on at least one piece of the information included in the registration request.

In operation 2 of S504, the base station RAN1 510 may transmit the registration request to an AMF1 530 selected based on the information received in operation 1 above. In this case, the UE capability, a UE indication, a network indication, a network ID, requested NS IDs, a cell ID, an access type, etc. may be included in the above respiration request.

In operation 3 of S505, the AMF1 530 may identify subscription information in an UDM1/UDR1 550 to identify whether multiple-access service may be used and what information is required for use, and may receive and record the required information.

In operation 3a of S506, the AMF1 530 may identify with a PCF1 540 to receive and record information about whether multiple-access support conditions are met.

In operation 4 of S507, the AMF1 530 may update the network selection list for multiple-access based on the information obtained in operations 2 and 3/3a. Further the AMF1 530 may determine whether to update the UE policy.

In operation 5 of S508, the AMF1 530 may transmit a registration response to the UE 500. In this case, the registration response may include a multi-access network selection list, UE policy, an AMF ID, etc. In S509, the UE 500 that has received the registration response may update the multi-access network selection list and UE policy.

According to an embodiment, multi-access network selection list may be configured as below:
sNW1, NW2, and NW3;
NW4 and NW5;
NW6, NW7, and NW8;
. . .
According to an embodiment, multi-access PDU session policy may be configured as below.
NW1 DNN/S-NSSAI1 3GPP and NW1 DNN/S-NSSAI1 non3GPP;
. . .

According to one embodiment, in S510, the terminal (e.g., UE) 500 may select a second 3GPP access network for multiple-access by reflecting the intention of the Application or user's selection, such as whether SNPN or PLMN is given priority.

In operation 6 of S511, a registration request may be transmitted to the RAN2 520, which is the base station of the selected network. In this case, the registration request may include UE capability, a UE indication, a network indication, a network ID, requested NS IDs, a cell ID, an access type, an AMF ID, etc.

In operation S512, the base station RAN2 520 may select a necessary AMF based on the information received in operation 6. Since the AMF ID corresponds to the same CN, the same AMF of the corresponding CN may be selected. In a case where the same AMF cannot be selected, all the contexts of the existing AMF1 530 may be relocated to a new AMF so that the AMF of operation 7 and the AMF of operation 1 become the same AMF. Then, in operation 7 of S513, the RAN2 520 may transmit the respiration request to the selected AMF1 530. In this case, the registration request may include UE capability, a UE indication, a network indication, a network ID, requested NS IDs, a cell ID, an access type, an AMF ID, etc.

In operation 8 of S514, the AMF1 530 may identify the subscriber information in the UDM/UDR1 550 to identify whether the multiple-access service may be used, what information is required for use, and may receive and record the necessary information.

In operation 9 of S515, the AMF1 530 may identify the PCF1 540 and receive and record information about whether the multiple-access support conditions are met.

In operation 10 of S516, the AMF1 530 may update the network selection list for multiple-access based on the information obtained in operations 7, 8, and 9. Further, the AMF1 530 may determine whether to update the UE policy.

In operation 11 of S517, the AMF1 530 may transmit a registration response to the UE 500. In this case, the registration response may include a multi-access network selection list, UE policy, etc. In S518, the UE 500 that has received the registration response may update the multi-access network selection list and UE policy, if necessary.

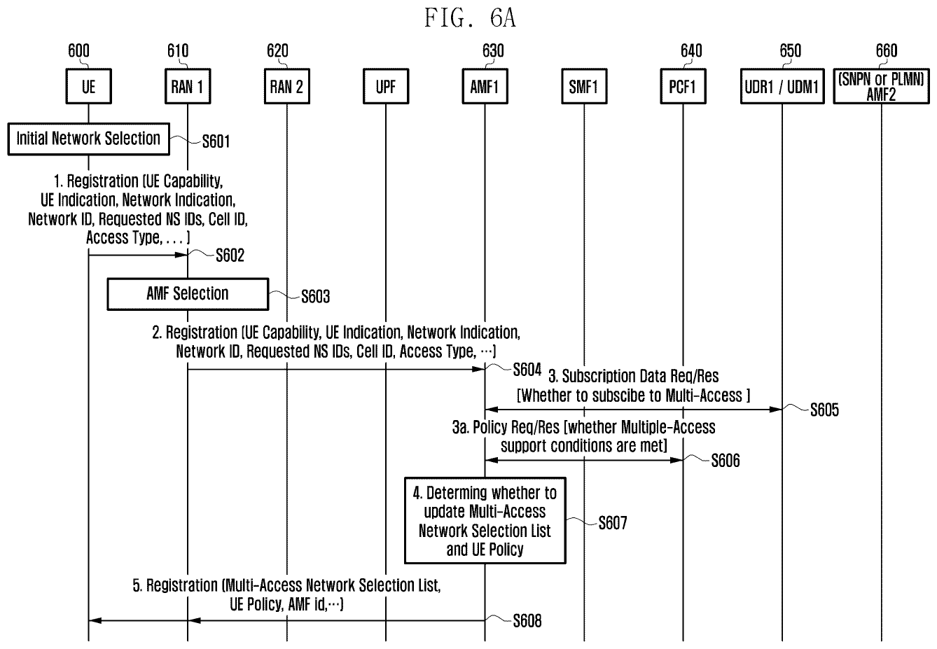

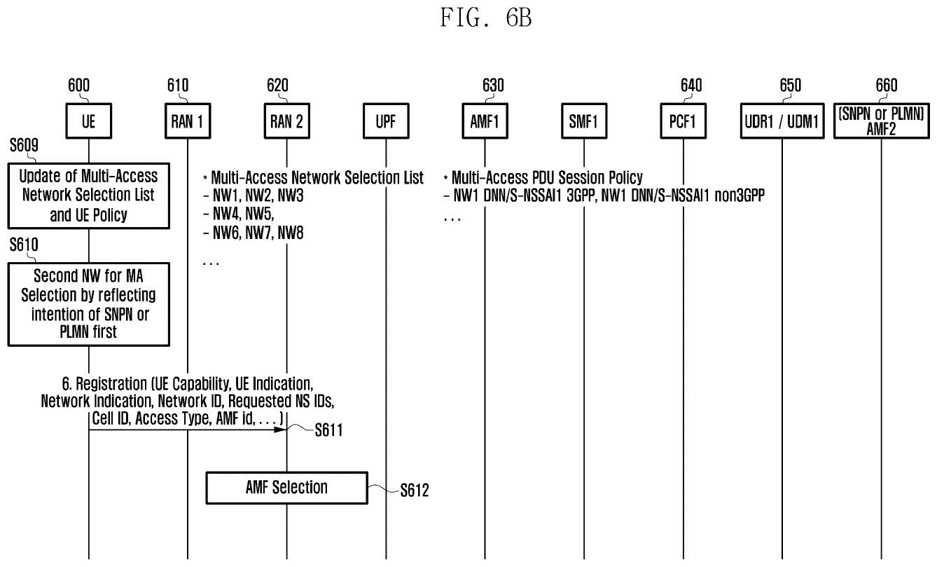

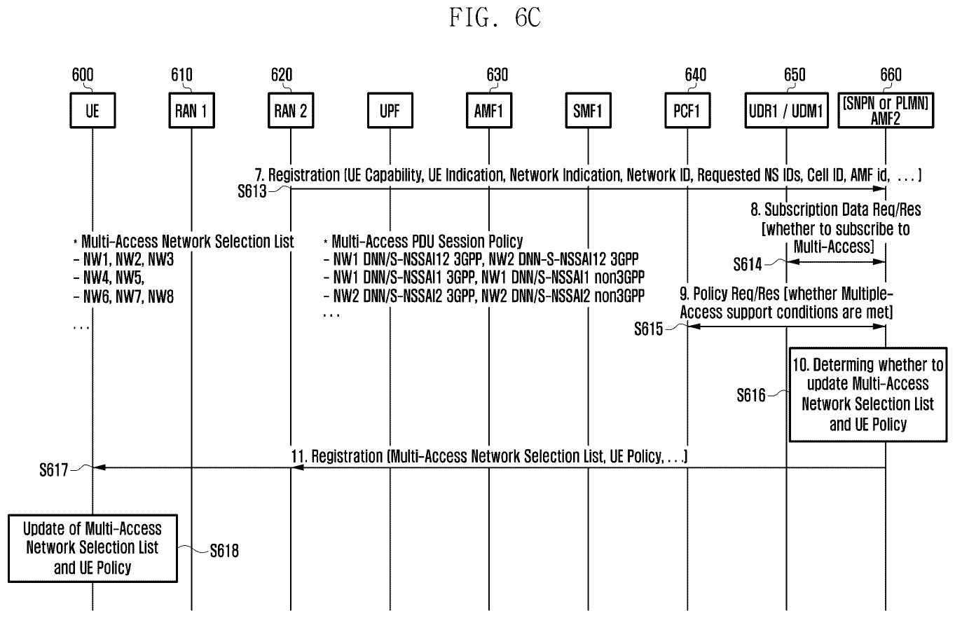

Meanwhile, FIGS. 6A to 6C illustrate signal flows of a network selection list update operation for 3GPP and 3GPP access traffic steering/switching/splitting of multiple CNs according to an embodiment of the present disclosure.

In S601, a terminal (e.g., UE) 600 that has selected a first network may transmit a registration request to an RAN1 610, which is the base station of a corresponding network, in the network selected in operation 1 of S602. The registration request may include UE capability indicating whether multiple-access may be used, a UE indication indicating whether multiple-access is to be used, a network indication indicating whether multiple-access is supported, a network ID to be accessed, requested network slice (NS) IDs to be accessed, a cell ID to which the UE has accessed, an access type to which the UE is accessed, etc.

In S603, the RAN1 610 may select an AMF based on at least one piece of the information included in the registration request.

In operation 2 of S604, the base station RAN1 610 may transmit the registration request to an AMF1 630 selected based on the information received in operation 1. In this case, the UE capability, a UE indication, a network indication, a network ID, requested NS IDs, a cell ID, an access type, etc. may be included in the above respiration request.

In operation 3 of S605, the AMF1 630 may identify subscriber information in an UDM1/UDR1 650 to identify whether multiple-access service may be used and what information is required for use, and may receive and record the required information.

In operation 3a of S606, the AMF1 630 may identify with a PCF1 640 to receive and record information about whether multiple-access support conditions are met.

In operation 4 of S506, the AMF1 630 may update the network selection list for multiple-access based on the information obtained in operations 2 and 3/3a. Further the AMF1 630 may determine whether to update the UE policy.

In operation 5 of S608, the AMF1 630 may transmit a registration response to the UE 600. In this case, the registration response may include a multi-access network selection list, UE policy, an AMF ID, etc. In S609, the UE 600 that has received the registration response may update the multi-access network selection list and UE policy.

According to an embodiment, multi-access network selection list may be configured as below:
NW1, NW2, and NW3;
NW4 and NW5;
NW6, NW7, and NW8;
. . .
According to an embodiment, multi-access PDU session policy may be configured as below.
NW1 DNN/S-NSSAI1 3GPP and NW1 DNN/S-NSSAI1 non3GPP;

According to one embodiment, in S610, the terminal (e.g., UE) 600 may select a second 3GPP access network for multiple-access by reflecting the intention of the Application or user's selection, such as whether SNPN or PLMN is given priority.

In operation 6 of S611, a registration request may be transmitted to the RAN2 620, which is the base station of the selected network. In this case, the registration request may include UE capability, a UE indication, a network indication, a network ID, requested NS IDs, a cell ID, an access type, an AMF ID, etc.

In operation S612, the base station RAN2 620 may select a necessary AMF based on the information received in operation 6. In this case, by looking at the AMF ID, it may be seen that it is an AMF of another CN, and an AMF that may be linked with the other CN may be selected as a candidate. Further, the registration request may be transmitted to an AMF2 660 selected in operation 7 of S613. In this case, the registration request may include UE capability, a UE indication, a network indication, a network ID, requested NS IDs, a cell ID, an access type, an AMF ID, etc.

In operation 8 of S614, the AMF2 660 may identify subscriber information in the corresponding UDM1/UDR1 650 through a linking process for roaming to the corresponding CN by looking at the AMF ID and identify whether multiple-access service may be used and what information is required for use, and may receive and record the necessary information.

In operation 9 of S615, the AMF2 660 may identify the PCF1 640 and receive and record information about whether the multiple-access support conditions are met.

In operation 10 of S616, the AMF2 660 may update the network selection list for multiple-access based on the information obtained in operations 7, 8, and 9. Further, the AMF2 660 may determine whether to update the UE policy.

In operation 11 of S617, the AMF2 660 may transmit a registration response to the UE 600. In this case, the registration response may include a multi-access network selection list, UE policy, etc. In S618, the UE 600 that has received the registration response may update the multi-access network selection list and UE policy, if necessary.

According to one embodiment of the disclosure, in a case where a new selection is required due to being out of the coverage of the second network, network selection using the updated multi-access network selection list and UE policy may be repeated from operation 6.

According to one embodiment of the disclosure, in a case where a new selection is required due to being out of the coverage of the first network, the process may be repeated from operation 1, or the process may be repeated from operation 6 in a state in which the second Network set as the first Network. Which of the two methods may be used may be determined by a UE indication, a network indication, or user subscription information, or policy.

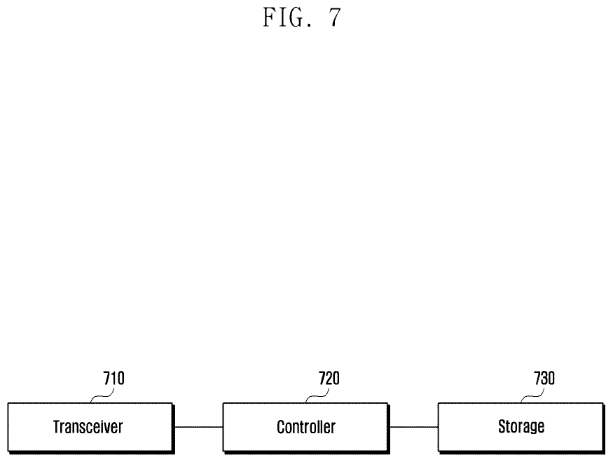

Meanwhile, FIG. 7 illustrates a structure of a terminal according to an embodiment of the present disclosure.

With reference to FIG. 7, the UE may include a transceiver 710, a controller 720 and a storage 730. In the disclosure, the controller may be defined as a circuit or an application-specific integrated circuit or at least one processor.

The transceiver 710 may transmit/receive a signal to/from a different network entity. The transceiver 710 may transmit/receive a signal to/from a base station or network entity such as an AMF, for example.

The controller 720 may control an overall operation of the UE according to the embodiments provided by the disclosure. For example, the controller 720 may control the signal flows between the blocks so that the operations according to the flowcharts are performed. Specifically, the controller 720 may perform the multi-access network selection list update and UE policy update according to an embodiment of the disclosure. Further, the controller may select a network for multiple-access.

The storage 730 may store at least one piece of information transmitted/received through the transceiver 710 and information created by the controller 720.

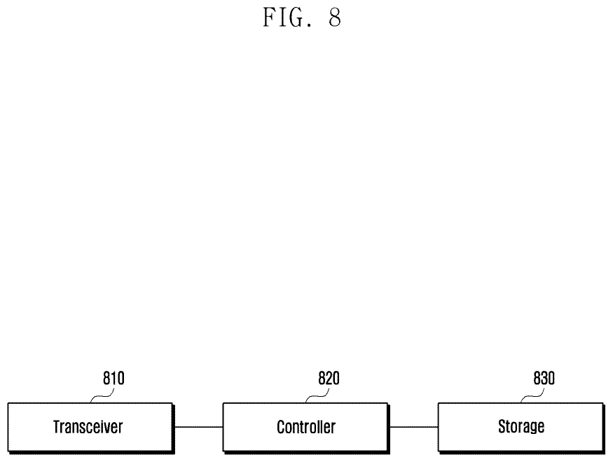

FIG. 8 illustrates a structure of a network entity according to an embodiment of the present disclosure. For example, the network entity in FIG. 8 may be an AMF that is selected based on at least one piece of information included in the registration request.

With reference to FIG. 8, the network entity may include a transceiver 810, a controller 820 and a storage 830. In the disclosure, the controller may be defined as a circuit or an application-specific integrated circuit or at least one processor.

The transceiver 810 may transmit/receive a signal to/from a different network entity. The transceiver 810 may transmit/receive a signal to/from a base station or UE, for example.

The controller 820 may control an overall operation of the network entity according to the embodiments provided by the disclosure. For example, the controller 820 may control the signal flows between the blocks so that the operations according to the flowcharts are performed. Specifically, the controller 820 may determine whether to update multi-access network selection list and UE policy according to an embodiment of the disclosure.

The storage 830 may store at least one piece of information transmitted/received through the transceiver 810 and information created by the controller 820.

Methods disclosed in the claims and/or methods according to embodiments described in the specification of the disclosure may be implemented by hardware, software, or a combination of hardware and software.

In a case where the methods are implemented by software, a computer-readable storage medium for storing one or more programs (software modules) may be provided. The one or more programs stored in the computer-readable storage medium may be configured for execution by one or more processors within an electronic device. The at least one program may include instructions that cause the electronic device to perform the methods in the claims and embodiments disclosed in the specification.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the program may be stored in a memory formed by any combination of some or all of them. Further, each constituent memory may be included in plural.

In addition, the programs may be stored in an attachable storage device which may access the electronic device through communication networks, such as the Internet, Intranet, local area network (LAN), wide LAN (WLAN), and storage area network (SAN) or a combination thereof. Such a storage device may access a device performing the embodiments of the disclosure via an external port. Further, a separate storage device on the communication network may access a device performing the embodiment of the disclosure.

In the above-described embodiments of the disclosure, an element included in the disclosure is expressed in the singular or the plural according to presented embodiments of the disclosure. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although the detailed description of the disclosure has described specific embodiments, it should be understood that various modifications may be made without departing from the scope of the disclosure. Therefore, the scope of the disclosure should not be limited to the described embodiments, but should be determined not only by the scope of the claims described below, but also by equivalents of the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
transmitting, to a first access and mobility management function (AMF) entity via a first base station, a first registration request message for a multiple access;
receiving, from the first AMF entity via the first base station, a first registration response message including at least one of a multi-access network selection list or information on a policy for the terminal in response to transmitting the first registration request message, in case that the at least one of the multi-access network selection list or the information on the policy for the terminal is updated;
updating, based on the first registration response message, the at least one of the multi-access network selection list or the information on the policy for the terminal; and
selecting a second base station for the multiple access based on the updated at least one of the multi-access network selection list or the information on the policy for the terminal.

2. The method of claim 1, further comprising:
transmitting, to the second base station, a second registration request message for the multiple access,
wherein the second registration request message is transmitted from the second base station to the first AMF entity.

3. The method of claim 2, wherein the first AMF entity is selected by the second base station, in case that an identity of an AMF entity included in the second registration request message corresponds to a same core network.

4. The method of claim 1, wherein a second registration request message is transmitted from the second base station to a second AMF entity.

5. The method of claim 4, further comprising:
receiving, from the second AMF entity via the second base station, a second registration response message including at least one of a multi-access network selection list or information on a policy for the terminal in case that the at least one of the multi-access network selection list or the information on the policy for the terminal is updated based on the second registration request message; and
updating the at least one of the multi-access network selection list or the information on the policy for the terminal based on the second registration response message.

6. The method of claim 1, wherein selecting the second base station comprises:
determining whether to select a stand-alone non-public network (SNPN) or a public land mobile network (PLMN) from a multi-access network access selection list, and
wherein the second base station for the multiple access is selected based on one of the SNPN or the PLMN.

7. The method of claim 1, wherein the first registration request message for the multiple access includes at least one of information of a capability for the terminal, a terminal indication, a network indication, requested network slice identities, a cell identity for the terminal, or an access type for the terminal.

8. A method performed by a first access and mobility management function (AMF) entity in a wireless communication system, the method comprising:
receiving, from a terminal via a first base station, a first registration request message for a multiple access, wherein the first registration request message for the multiple access includes at least one of information of a capability for the terminal, a terminal indication, a network indication, a requested network slice identities, a cell identity for the terminal, or an access type for the terminal;
determining whether to update at least one of a multi-access network selection list or information on a policy for the terminal; and
transmitting, to the terminal via the first base station, a first registration response message including at least one of the at least one of the multi-access network selection list or the information on the policy for the terminal in response to receiving the first registration request message in case that the at least one of a multi-access network selection list, or the information on the policy for the terminal is updated.

9. The method of claim 8, further comprising:
receiving, from a second base station, a second registration request message for the multiple access, the second base station being selected by the terminal based on the updated at least one of the multi-access network selection list or the information on the policy for the terminal.

10. The method of claim 8, further comprising:
transmitting, to a unified data management (UDM), a request message for subscription data;
determining whether a multiple access service is available for the terminal based on information obtained in response to transmitting the request message; and
determining, based on policy control function (PCF) entity information, whether a multiple access support condition is met.

11. A terminal in a wireless communication system, the terminal comprising:
a transceiver; and
at least one processor configured to:
transmit via the transceiver, to a first access and mobility management function (AMF) entity via a first base station, a first registration request message for a multiple access,
receive, from the first AMF entity via the first base station, a first registration response message including at least one of a multi-access network selection list or information on a policy for the terminal in response to transmitting the first registration request message, in case that the at least one of the multi-access network selection list or the information on the policy for the terminal is updated,
update, based on the first registration response message, the at least one of the multi-access network selection list or the information on the policy for the, and
select a second base station for the multiple access based on the updated at least one of the multi-access network selection list or the information on the policy for the terminal.

12. The terminal of claim 11, wherein the at least one processor is further configured to:
transmit, to the second base station via the transceiver, a second registration request message for the multiple access, and
wherein the second registration request message is transmitted from the second base station to the first AMF entity.

13. The terminal of claim 12, wherein the first AMF entity is selected by the second base station, in case that an identity of an AMF entity included in the second registration request message corresponds to a same core network.

14. The terminal of claim 11, wherein a second registration request message is transmitted from the second base station to a second AMF entity.

15. The terminal of claim 14, wherein the at least one processor is further configured to:
receive, from the second AMF entity via the second base station, a second registration response message including at least one of a multi-access network selection list, or information on a policy for the terminal in case that the at least one of the multi-access network selection list or the information on the policy for the terminal is updated based on the second registration request message; and
update the at least one of the multi-access network selection list, or the information on the policy for the terminal based on the second registration response message.

16. The terminal of claim 11, wherein the at least one processor is further configured to:
determine whether to select a stand-alone non-public network (SNPN) or a public land mobile network (PLMN) from a multi-access network access selection list, and
wherein the second base station for the multiple access is selected based on one of the SNPN or the PLMN.

17. The terminal of claim 11, wherein the first registration request message for the multiple access includes at least one of information of a capability for the terminal, a terminal indication, a network indication, requested network slice identities, a cell identity for the terminal, or an access type for the terminal.

18. A first access and mobility management function (AMF) entity in a wireless communication system, the AMF entity comprising:
a transceiver; and
at least one processor configured to:
receive via the transceiver, from a terminal via a first base station, a first registration request message for a multiple access, wherein the first registration request message for the multiple access includes at least one of information of a capability for the terminal, a terminal indication, a network indication, a requested network slice identities, a cell identity for the terminal, or an access type for the terminal,
determine whether to update at least one of a multi-access network selection list, or information on a policy for the terminal, and
transmit, to the terminal via the first base station, a first registration response message including at least one of the at least one of the multi-access network selection list or the information on the policy for the terminal in response to receiving the first registration request message in case that the at least one of a multi-access network selection list, or the information on the policy for the terminal is updated.

19. The first AMF entity of claim 18, wherein the at least one processor is further configured to:
receive, from a second base station via the transceiver, a second registration request message for the multiple access, the second base station being selected by the terminal based on the updated at least one of the multi-access network selection list, or the information on the policy for the terminal.

20. The first AMF entity of claim 18, wherein the at least one processor is further configured to:
transmit, to a unified data management (UDM) via the transceiver, a request message for subscription data,
determine whether a multiple access service is available for the terminal based on information obtained in response to transmitting the request message, and
determine, based on a policy control function (PCF) entity information, whether a multiple-access support condition is met.
